(19) United States
(12) Patent Application Publication
(10) Pub. No.: US 2009/0299840 A1
(43) Pub. Date: Dec. 3, 2009

(54) Methods And Systems For Creating Variable Response Advertisements With Variable Rewards

(76) Inventor: Scott Smith, Boulder, CO (US)

Correspondence Address: LATHROP & GAGE LLP, 4845 PEARL EAST CIRCLE, SUITE 201, BOULDER, CO, 80301, US

(21) Appl. No.: 12/471,269

(22) Filed: May 22, 2009

Related U.S. Application Data
(60) Provisional application No. 61/055,364, filed on May 22, 2008.

(51) Int. Cl. G06Q 30/00

(52) U.S. Cl. 705/14.19

(57) ABSTRACT

System, method and software product create variable advertisements with rewards. A first variable response advertisement with at least one button is generated. Selection and response behavioral data resulting from the variable response advertisement is collected and stored. A new variable response advertisement is generated based upon analysis of the selection and response behavioral data, and the steps of collecting and generating a new variable response advertisement are repeated until a sequence end is reached, whereupon at least one reward is generated.

### RELATED APPLICATIONS

This application claim priority to U.S. Patent Application Ser. No. 61/055,364, filed May 22, 2008, which is incorporated herein by reference.

### BACKGROUND

Advertising on the World Wide Web has two advantages: one is branding and another is direct sales. Branding is a process of impressing a company name or product into the consumers' subconscious, permitting the consumer to easily recall the impression into the conscious when they are ready to buy a product. Direct selling allows consumers to go directly to the advertiser's website to buy the products.

Advertisements may take many forms including static text, static pictures, moving text, moving pictures, and so on. Each advertiser tries to make their advertisement more noticable to the user than their competitor. The advertiser also tries to maximize return from the advertisement by making the content more compelling. However, these advertisements do not adapt to a perceived mood of the user to maximize the achieved response.

### SUMMARY

In an embodiment, a system creates variable response advertisements with variable rewards, and includes a generator for generating a web page with a variable response advertisement, a database for storing information of the variable response advertisement and response data collected from a user interacting with the variable response advertisement, and a response applet for collecting response data from the user. The generator generates the variable response advertisement based upon analysis of the response data and generates a reward for the user based upon accumulated analysis results upon reaching an end of a sequence of variable response advertisements.

In another embodiment, a method creates variable advertisements with rewards. A first variable response advertisement with at least one button is generated. Selection and response behavioral data resulting from the variable response advertisement is collected and stored. A new variable response advertisement is generated based upon analysis of the selection and response behavioral data. The steps of collecting and generating a new variable response advertisement are repeated until a sequence end is reached, whereupon at least one reward is generated.

In another embodiment, a software product has instructions, stored on computer-readable media, wherein the instructions, when executed by a computer, perform steps for creating variable advertisements with rewards. The software product includes instructions for generating a first variable response advertisement with at least one button, instructions for collecting and storing selection and response behavioral data resulting from the variable response advertisement, instructions for generating a new variable response advertisement based upon analysis of the selection and response behavioral data, and instructions for repeating the instructions for collecting and generating a new variable response advertisement until a sequence end is reached, whereupon at least one reward is generated

### BRIEF DESCRIPTION OF THE FIGURES

FIG. 1 is a block diagram illustrating one exemplary system for creating variable response advertisements with rewards, in an embodiment.

FIG. 2 is a block diagram showing a variable response advertisement of FIG. 1 in further detail.

FIG. 3 shows a block diagram illustrating an interaction between the generator and the database of FIG. 1, for creating a web page.

FIG. 4 is a data flow diagram illustrating an exemplary sequence of variable response advertisements, in an embodiment.

FIG. 5 shows a flow chart illustrating one exemplary process for displaying variable response advertisements with rewards, in an embodiment.

FIG. 6 shows a flow chart of one exemplary process for creating variable response advertisements with rewards, in an embodiment.

### DETAILED DESCRIPTION OF THE FIGURES

The present disclosure relates to systems and methods for creating variable response advertisement with variable rewards, which balances the possibility of a user achieving a greater reward with the possibility of the user losing past banked rewards, in a manner similar to gambling, thereby compelling and instilling the user to stay engaged and/or continually return to the advertisement.

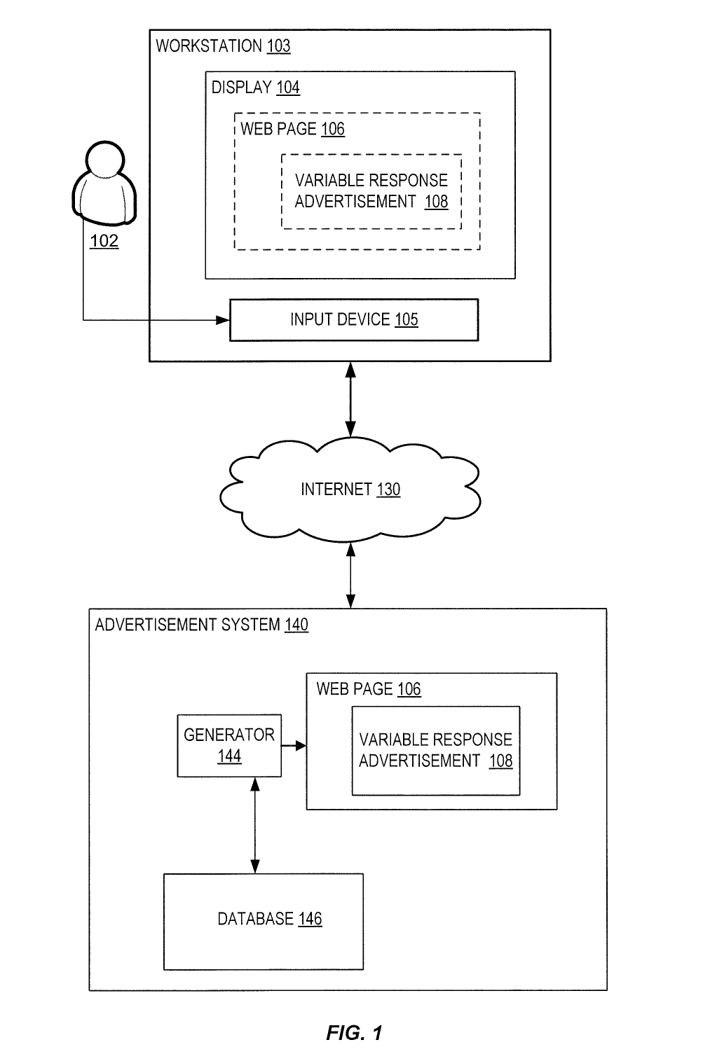

FIG. 1 is a block diagram illustrating one exemplary advertisement system 140 for creating variable response advertisements 108 with rewards. A user 102 interacts with a workstation 103 that is in communication with advertisement system 140 via the Internet 130. Although Internet 130 is shown in FIG. 1, other suitable telecommunication networks that include one or more of computer networks, cable, satellite, radio waves or the like, may be used for communication between workstation 103 and advertisement system 140. Workstation 103 has at least a display 104 and an input device 105. Advertisement system 140 generates a variable response advertisement 108 for display on display 104 of workstation 103 to entice and hook interaction by user 102. Workstation 103 preferably includes a web browser (not shown) for displaying a web page 106 with a variable response advertisement 108 on display 104. User 102 is enticed to use input device 105 to interact with variable response advertisement 108, thereby interacting with advertisement system 140.

In an alternate embodiment, workstation 103 is for example one of a television with a remote control, a kiosk with a display and input device, a two-way radio transceiver with a display and input buttons, a cellular phone, a personal data assistant (PDA) or other similar device with a display and input device. Where workstation 103 is a television with a remote control, variable response advertisement 108 is included within a television commercial for display on the television.

Advertisement system 140 includes a generator 144 and a database 146. Advertisement system 140 is for example a computer or a network of computers. Database 146 stores data related to web page 106 and variable response advertisement 108. Generator 144 generates web page 106 with variable response advertisement 108 and operates to store, retrieve and analyze responses to variable response advertisement 108. Generator 144 generates web page 106 to include variable response advertisement 108 based upon information of database 146. Generator 144 then sends web page 106 to workstation 103 via Internet 130 for display upon display 104. Generator 144 receives responses from user 102 via input device 105 and internet 130 and stores these responses within database 146.

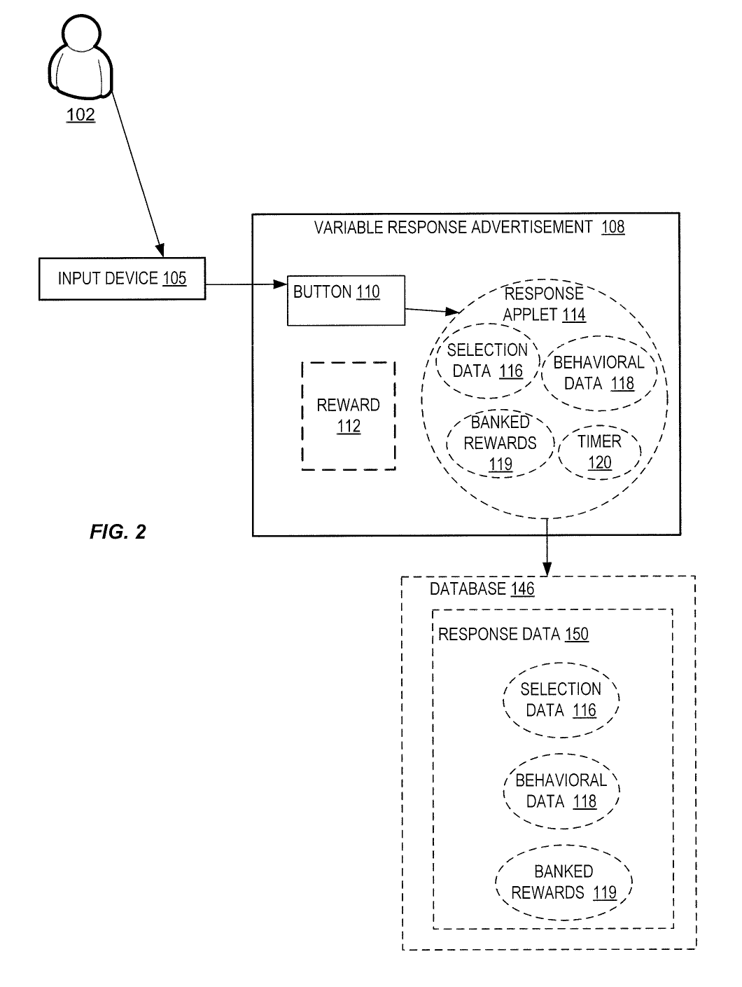

FIG. 2 is a block diagram showing variable response advertisement 108 of FIG. 1 in further detail. Variable response advertisement 108 includes a response applet 114, a button 110 and optionally a reward 112. Response applet 114 has selection data 116, response behavioral data 118 and a timer 120. Response applet 114 may be embedded within web page 106 for collecting and recording selection data 116, response behavioral data 118, and banked rewards 119 based upon interaction of user 102 with variable response advertisement 108 using input device 105. Selection data 116 represents data captured based upon selection of button 110 by user 102. Response behavioral data 118 represents information captured by response applet 114 based upon determined behavior of user 102 while interacting with variable response advertisement 108. For example, response behavioral data 118 may be the number of clicks user 102 pressed on button 110, the position of cursor disposed on button 110, the response time for the first click, the time between clicks, the length of time user 102 interacted with button 110 after reward 112 appeared or disappeared, and the like. Banked rewards 119 represents a series of rewards 112 that user 102 accumulates while interacting with variable response advertisement 108. That is, user 102 may accumulate rewards through continued interacting with advertisement system 140. Other information may be determined by response applet 114 without departing from the scope hereof.

Response applet 114 records selection data 116 based upon interaction of user 102 with input device 105 and button 110. Response applet 114 uses timer 120 to determine and record the amount of time taken by user 102 to interact with button 110. In one embodiment, variable response advertisement 108 is momentarily displayed within web page 106. For example, timer 120 is set for a maximum of 10 seconds and starts running as soon as variable response advertisement 108 is displayed. After the 10-second interval expires, response applet 114 removes variable response advertisement 108 from web page 106, thus teaching user 102 that there is a limited response window and instilling a ‘need to respond’ within the subconscious of user 102.

In one embodiment, response applet 114 uses reward 112 to determine risk/reward tolerance levels of user 102. For example, response applet 114 first displays reward 112 within variable response advertisement 108, then after a certain period, it removes the reward 112 from variable response advertisement 108. A timer 120 is set to 10 seconds and starts to count down as soon as response applet 114 removes reward 112. After the 10-second interval expires (e.g., when timer 120 reaches zero), response applet 114 permanently removes reward 112 from variable response advertisement 108. On the other hand, if user 102 clicks on button 110 within the 10-second interval, timer 120 is reset for a maximum of 5 seconds and starts counting down. After the 5-second interval expires, response applet 114 displays a new reward 112. The value of reward 112 increases for each interaction to entice user 102 to continue interacting with variable response advertisement 108 in hopes of gaining greater rewards.

In particular, response applet 114 collects and records responses (or lack thereof) of user 102 as response behavioral data 118 and sends any selection data 116, response behavioral data 118, and banked rewards 119 to advertisement system 140 for analysis and for storing within database 146 as response data 150.

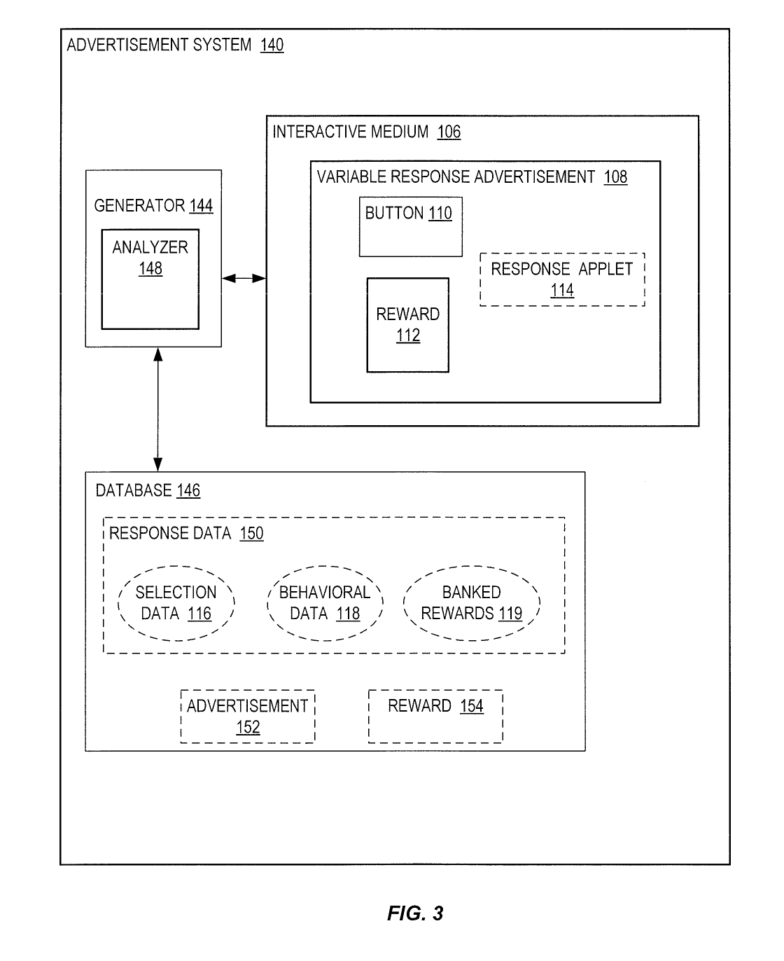

FIG. 3 is a block diagram illustrating exemplary interaction between generator 144 and database 146 to create web page 106. Database 146 includes response data 150, advertisement 152 and reward 154. Generator 144 is shown with an analyzer 148 for analyzing response data 150. Analyzer 148 retrieves and analyzes response data 150 from database 146. Response data 150 includes selection data 116, response behavioral data 118, and may be used to determine user's skills, knowledge, mood, risk/reward profile and other such information. In one example, button 110 is programmed to require user 102 to click on it several times before a response is displayed to user 102. The number of mouse clicks made by user 102 is then used to determine the frustration level of user 102 toward variable response advertisement 108. Analyzer 148 may also utilize the response time to determine the curiosity level of user 102. Motor skills of user 102 are determined by analyzing the position of the cursor in relation to button 110, for example. Analyzer 148 may use the length of time in which user 102 interacts with button 110 after reward 112 is removed to determine the risk/reward profile.

Once response data 150 has been analyzed by analyzer 148, generator 144 retrieves advertisement 152 and reward 154 from database 146 and optionally modifies advertisement 152 and reward 154 to create and/or update web page 106 with variable response advertisement 108 having at least one button 110 and/or reward 112 and response applet 114. That is, variable response advertisement 108 may be modified and redisplayed or new variable response advertisement 108 created based upon results of analyzer 148.

As appreciated, response data 150 may be used to determine the challenges, intellectual skill, state of mind, risk/reward profile, propensity to gamble, mood, knowledge, feedback loop (bio-feedback), type of prizes that is desired, and visual and auditory stimulation, and variations thereof.

In one embodiment, artificial intelligence may be used in determining mood and bio-feedback of user 102. One example of artificial intelligence is affective computing. Affective computing assists in understanding physical state and/or behavior of user 102 through analysis of facial expressions, body posture and gestures, for example as captured by a webcam. In another embodiment, a microphone is used to capture speech and other noises made by user 102. Emotional speech processing may then be used to analyze speech patterns of user 102 and, by correlating these speech patterns, determine an emotional state of user 102. Vocal parameters and prosody features such as pitch variables and speech rate are analyzed through speech pattern recognition. The detection and processing of facial expression is achieved through various methods such as optical flow, hidden Markov modeling, neural network processing and/or active appearance modeling. Facial expression and speech pattern data gathered using the above methods are often analogous to the cues humans use to perceive emotions in others. Additionally, one or more sensors may be embedded within the mouse for measuring physiological data such as skin temperature and galvanic resistance. The physiological data may also be used for detecting emotional cues. The use of specialist hardware may be more applicable where a kiosk if made available for public use. (Most computer hardware used within the home and/or office do not currently include such biometric sensors.)

In one example, button 110 includes a picture such that additional information may be determined from user 102 based upon the location within the picture that is selected by user 102. By judiciously selecting the picture for display upon button 110, different information may be determined from user 102.

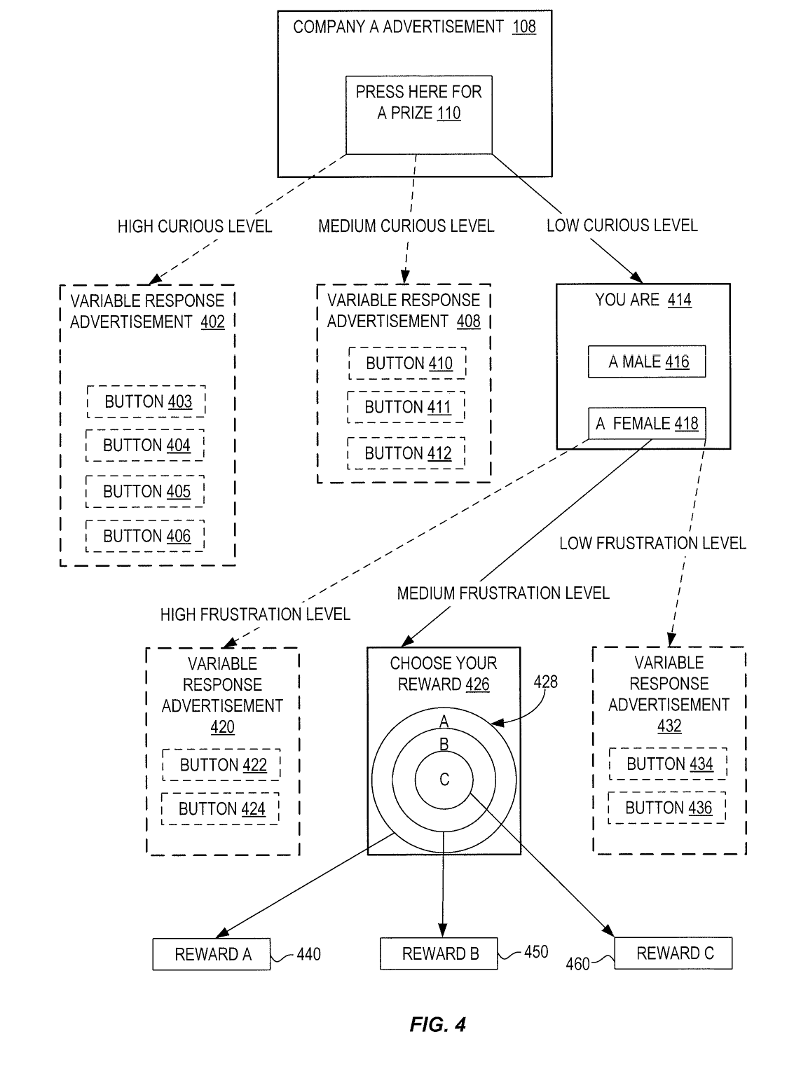

FIG. 4 is a data flow diagram illustrating exemplary interaction of user 102 with variable response advertisement 108. Starting at the top of the figure, variable response advertisement 108 is displayed to user 102. Response data (e.g., response data 150) determined from user 102 is then analyzed to determine subsequent displayed options and thereby guiding advertisement system 140 to create variable response advertisements 402, 408, 414, 420, 426 and 432. For example, response behavioral data 118 is used to determine curiosity level, frustration level, risk/reward tolerance level, gambling propensity, and motor skills of user 102.

As shown in FIG. 4, variable response advertisement 108 shows “COMPANY A ADVERTISEMENT” and includes button 110 to entice a response from user 102. Button 110 displays “PRESS HERE IF YOU WOULD LIKE TO RECEIVE A PRIZE”. In this example, upon noticing button 110, user 102 selects button 110 within a time interval (e.g., between 0 and 10 seconds). Button 110 may be a flashing button, a flying button, hyperlink text or any variation and/or combination thereof. The selection of button 110 and response time are recorded by response applet 114 as selection data 116 and response behavioral data 118. Response applet 114 sends selection data 116 and response behavioral data 118 to advertisement system 140 to be recorded as response data 150 in database 146.

Analyzer 148 within advertisement system 140 then retrieves and analyzes response data 150 to determine a curiosity level of user 102. If, for example, the response time is 2 seconds, analyzer 148 determines that the curiosity level of user 102 is high; if the response time is 4 seconds, analyzer 148 determines that the curiosity level of user 102 is medium; and if the response time is 9 seconds, analyzer 148 determines that the curiosity level of user 102 is low. Generator 144 then generates a next variable response advertisement based upon the determined curiosity level of user 102. Thus, the determined mood of user 102 is used to customize the presented advertisement.

Continuing with the example of FIG. 4, generator 144 generates variable response advertisement 402 if user 102 is determined as having a high curiosity level. For example, variable response advertisement 402 has a treasure hunt theme with four buttons 403, 404, 405 and 406 because a highly curious user is more likely to interact with a treasure hunting theme. Buttons 403, 404, 405 and 406 are presented as mystery buttons to further entice user 102 to interact.

On the other hand, in the example of FIG. 4, advertisement 414 is generated if user 102 is determined as having a low curiosity level. Advertisement 414 has a more straight forward theme and presents user 102 with two buttons 416 and 418 that allow user 102 to select a gender; button 416 for “Female” and button 418 for “Male”—thus a simple choice is presented to user 102.

Variable response advertisement 408 represents yet another theme and complexity level that is generated and presented to user 102 if the curiosity level of user 102 is determined as medium. Variable response advertisement 408 has three buttons 410, 411 and 412.

Buttons 403-406, 410-412, 416 and 418 may be configured to measure further mood and bio-feedback information from user 102. In the example of FIG. 4, buttons 416 and 418 are configured to determine the frustration level of user 102 by failing to respond to initial selection, thereby allowing the number and speed of mouse clicks made by user 102 to be measured. In the example of FIG. 4, response applet 114 records that user 102 has selected button 416, and clicked on button 416 five times and sends the selection data 116 and the response behavioral data 118 to advertisement system 140 for storing in database 146 as response data 150. Analyzer 148 then analyzes response data 150 to determine the frustration level of user 102. For example, it may be predetermined that 1 or 2 mouse clicks indicate a low frustration level, 3 or 4 mouse clicks indicate a medium frustration level and 5 or more mouse clicks indicate a high frustration level. In the example of FIG. 4, user 102 makes 3 mouse clicks and is determined to have a moderate frustration level.

Generator 144, based upon the determined frustration level of user 102, generates one of variable response advertisement 420, 426 and 432. Variable response advertisement 420 is generated if user 102 is determined as having a high level of frustration; variable response advertisement 426 is generated if user 102 is determined as having a medium level of frustration; and variable response advertisement 432 is generated if user 102 is determined to have a low frustration level. In the example of FIG. 4, generator 144 accesses database 146 and generates variable response advertisement 426 since user 102 has been determined as a male having a low curiosity level and a moderate frustration level.

In the example of FIG. 4, advertisement 426 is generated to measure the motor skills of user 102. Button 428 is displayed as a target with areas A, B and C that correspond to reward A, reward B, and reward C, respectively. User 102 is invited to use the mouse to ‘shoot’ at the target. Response applet 114 determines the location within button 428 that is ‘hit’ by user 102. In one embodiment, button 428 moves randomly across display 104, thereby increasing difficulty of hitting the target. In the example of FIG. 4, areas A, B and C correspond to low, medium, and good levels of motor skill, respectively.

Analyzer 148 determines the motor skill level of user 102 based upon returned information of response applet 114 and generates an appropriate reward. This reward may be in the form of a discount coupon from the advertiser, or other such coupon. Alternatively, the reward may be a link to other web pages displaying appropriate offers and incentives of the advertiser. Since the reward is specifically selected for user 102 based upon determined mood and bio-feedback, user 102 is more likely to accept and use the reward. In the example of FIG. 4, generator 144 generates reward 440 if user 102 is determined to have poor motor skills; generator 144 generates reward 450 if user 102 is determined to have medium motor skills; and generator 144 generates reward 460 if user 102 is determined to have good motor skills.

Since rewards 440, 450 and 460 are specifically generated for a particular user, this also encourages habitual behavior, over time, by the user and further conditions the user to return to the advertisement in the future to re-engage the process. In the example of FIG. 4, reward 440 is appropriate for a male having a low curiosity level, a moderate frustration level and poor motor skills; reward 450 is appropriate for a male with low curiosity level, a moderate frustration level and moderate motor skill; and reward 460 is appropriate for a male having a low curiosity level, moderate frustration level and good motor skills.

As appreciated, variable response advertisements and rewards may have more or fewer levels and steps than those shown in the example of FIG. 4 and have determine other bio-feedback metrics and user characteristics for use in generating appropriate advertisements and rewards without departing from the scope hereof.

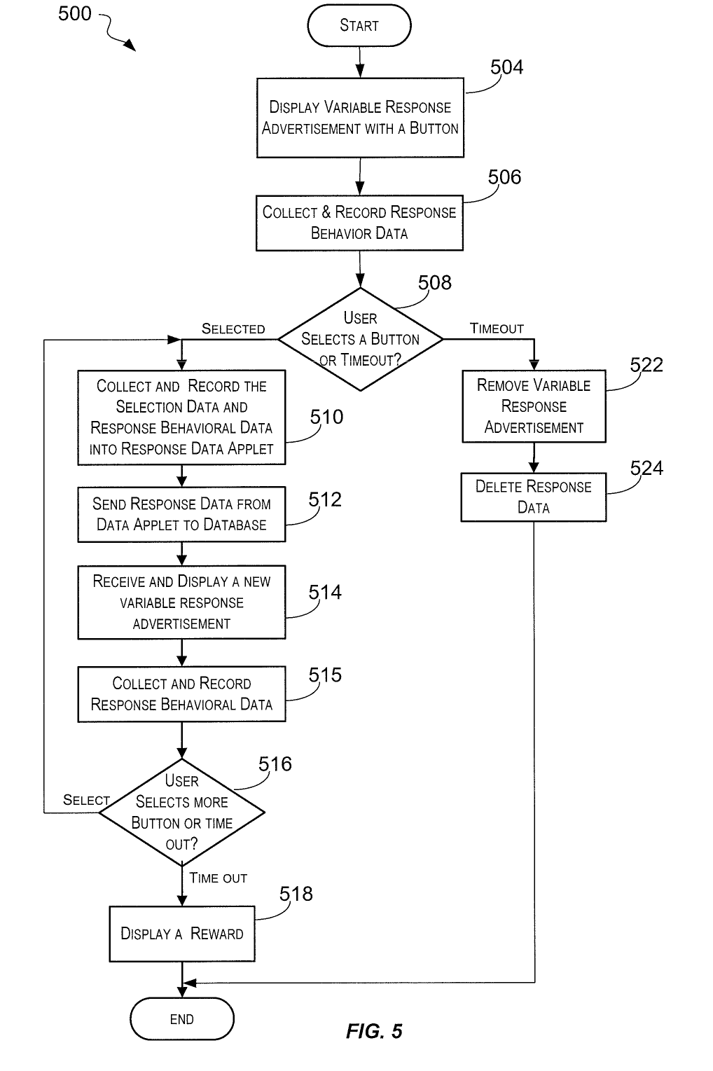

FIG. 5 is a flow chart illustrating one exemplary process 500 for displaying variable response advertisements. Process 500 operates, for example, within response applet 114 and/or a browser of workstation 103. In step 504, a variable response advertisement with at least one button is displayed on a web page. In one example of step 504, variable response advertisement 108 is displayed upon display 104. In step 506, process 500 collects and records response behavioral data. In one example of step 506, response applet 114 collects response behavioral data 118. Step 508 is a decision step based upon the user's input selection and a timer. If, in step 508, user 102 selects button 110, process 500 continues with step 510, otherwise if the user has not made a selection within a defined period, process 500 continues with step 522. In step 522, process 500 removes variable response advertisement 108 from the display. In one example of step 522, response applet 114 removes variable response advertisement 108 from display 104. In step 524, process 500 deletes collected response data. In one example of step 524, response applet 114 deletes response behavioral data 118 if it exists. Process 500 then ends.

In step 510, process 500 records the selection. In one example of step 510, response applet 114 records the selection made by user 102 within selection data 116. In step 512, process 500 sends selection and response data to the advertisement system. In one example of step 512, response applet 114 sends response data 150 to advertisement system 140. In step 514, process 500 receives and displays a new variable response advertisement. In one example of step 514, response applet 114 receives a new variable response advertisement 108 from advertisement system 140 and displays variable response advertisement 108 on display 104. In step 515, process 500 collects and records response behavioral data. In one example of step 515, response applet 114 collects response behavioral data 118. Step 516 is a decision. If, in step 516, a user selection occurs, process 500 continues with step 510; otherwise process 500 continues with step 518 if no user selection is made within a defined period. Steps 510-516 repeat until no user selection is received or the end of the variable response advertisement sequence is reached.

In step 518, process 500 displays a reward. In one example of step 518, response applet 114 displays reward 450. Process 500 then ends.

As appreciated, the order of steps 504 through 524 may vary without departing from the scope hereof.

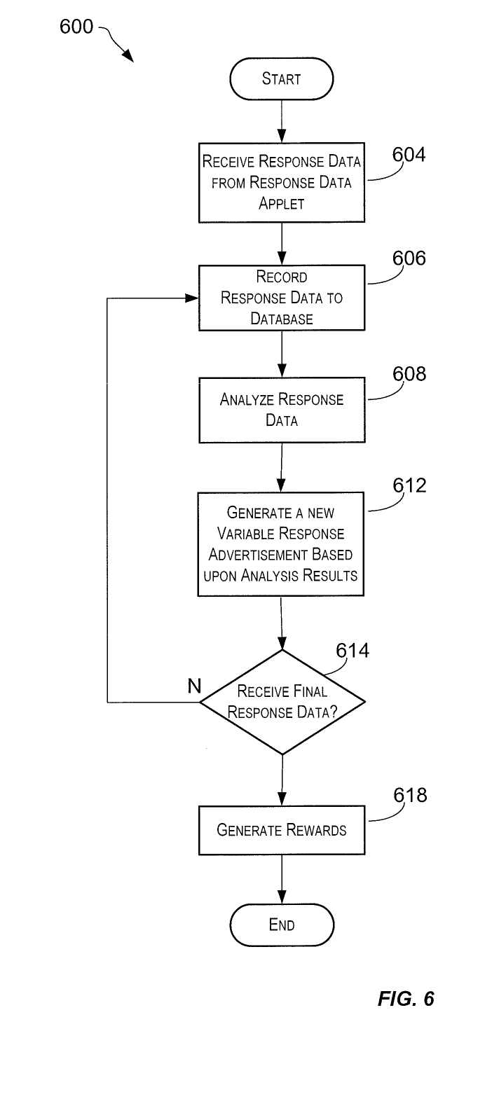

FIG. 6 is a flow chart illustrating one exemplary process 600 for creating variable advertisements with rewards. Process 600 may operate within advertisement system 140, FIG. 1. In step 604, process 600 receives response data. In one example of step 604, generator 144 receives response data 150 (optionally in the form of selection data 116 and response behavioral data 118) from response applet 114. In step 606, process 600 records response data in a database. In one example of step 606, generator 144 stores response data 150 within database 146. In step 608, process 600 analyzes the response data. In one example of step 608, generator 144 utilizes analyzer 148 to analyze response data 150.

In step 612, process 600 generates a new variable response advertisement based upon the analysis results of step 608. In one example of step 612, generator 144 generates variable response advertisement 414 based upon analysis results for variable response advertisement 108. Step 614 is a decision step. If, in step 614, process 600 determines that no further variable response advertisements remain in the current sequence, process 600 continues with step 618; otherwise process 600 continues with step 604. In one example of step 614, generator 144 determines that further variable response advertisements are available and continues with step 604. Steps 604 through 614 repeat until the current sequence has completed or the user does not respond within a defined period.

In step 618, process 600 generates a reward based upon the user selected sequence of variable response advertisements. In one example of step 618, generator 144 generates reward 450. Process 600 then ends.

As appreciated, the order of steps 604 through 618 may vary without departing from the scope hereof.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present methods and systems, which, as a matter of language, might be said to fall there between.

What is claimed is:

1. A system for creating variable response advertisements with variable rewards, comprising:
a generator for generating a web page with a variable response advertisement;
a database for storing information of the variable response advertisement and response data collected from a user interacting with the variable response advertisement; and
a response applet for collecting response data from the user;
the generator generating the variable response advertisement based upon analysis of the response data and generating a reward for the user based upon accumulated analysis results upon reaching an end of a sequence of variable response advertisements.

2. The system of claim 1, wherein the response data includes bio-feedback information of the user.

3. The system of claim 2, wherein the response data comprises selection and response behavioral data.

4. The system of claim 1, wherein the variable response advertisement includes at least one button available for selection by the user.

5. The system of claim 1, the generator further comprising an analyzer for analyzing the response data.

6. The system of claim 5, wherein the analyzer analyzes the response data to determine one or more of frustration, challenges, risk/reward profile, propensity to gamble, curiosity, intellectual skills, motor skills, state of mind, mood and knowledge.

7. A method for creating variable advertisements with rewards, comprising:
generating a first variable response advertisement with at least one button;
collecting and storing selection and response behavioral data resulting from the variable response advertisement;
generating a new variable response advertisement based upon analysis of the selection and response behavioral data; and
repeating the steps of collecting and generating a new variable response advertisement until a sequence end is reached, whereupon at least one reward is generated.

8. The method of claim 7, the step of collecting comprising using a response applet to collect response behavioral data.

9. The method of claim 7, further comprising the step of terminating the sequence if a response is not received within a predefined period.

10. The method of claim 9, further comprising the step of deleting the cumulated response data upon termination of the sequence.

11. The method of claim 7, further comprising the step of determining behavioral data associated with one or more of frustration, challenge, risk/reward profile, propensity to gamble, curiosity, intellectual skills, motor skills, state of mind, mood and knowledge.

12. A software product comprising instructions, stored on computer-readable media, wherein the instructions, when executed by a computer, perform steps for creating variable advertisements with rewards, comprising:
instructions for generating a first variable response advertisement with at least one button;
instructions for collecting and storing selection and response behavioral data resulting from the variable response advertisement;
instructions for generating a new variable response advertisement based upon analysis of the selection and response behavioral data; and
instructions for repeating the instructions for collecting and generating a new variable response advertisement until a sequence end is reached, whereupon at least one reward is generated.

13. The method of claim 12, the instructions for collecting comprising instructions for using a response applet to collect response behavioral data.

14. The method of claim 12, further comprising instructions for terminating the sequence if a response is not received within a predefined period.

15. The method of claim 14, further comprising instructions for deleting the cumulated response data upon termination of the sequence.

16. The method of claim 12, further comprising instructions for determining behavioral data associated with one or more of frustration, challenge, risk/reward profile, propensity to gamble, curiosity, intellectual skills, motor skills, state of mind, mood and knowledge.
